(19) United States
(12) Patent Application Publication
(10) Pub. No.: US 2012/0314777 A1
(43) Pub. Date: Dec. 13, 2012

(54) METHOD AND APPARATUS FOR GENERATING A DISPLAY DATA STREAM FOR TRANSMISSION TO A REMOTE DISPLAY

(75) Inventors: Lei Zhang, Richmond Hill (CA); Collis Q. Carter, Richmond Hill (CA); David I. J. Glen, Toronto (CA)

(73) Assignee: ATI TECHNOLOGIES ULC, Markham (CA)

(21) Appl. No.: 13/158,668

(22) Filed: Jun. 13, 2011

(51) Int. Cl. H04N 7/26

(52) U.S. Cl. 375/240.26; 375/240.01; 375/E07.026

(57) ABSTRACT

A method and apparatus are described for generating a display data stream for transmission to a remote display. A display control unit in a processor is configured to multiplex the outputs of a plurality of display controllers to generate a video data stream. A video compression engine (VCE) in the processor receives the video data stream directly from the display control unit without having to go through an external memory or an external display interface. The VCE compresses the video data stream, and optionally encrypts the video data stream. In one embodiment, audio and video data streams may be synchronized into a multiplexed, (and optionally encrypted), audio/video stream before being forwarded for transmission to a remote display. In another embodiment, separate audio and video streams (optionally encrypted) may be forwarded for transmission to the remote display.

### FIELD OF INVENTION

The present invention is generally directed to a processor. More particularly, the present invention is directed to a processor that generates either separate or multiplexed audio and video streams that are forwarded for transmission to a remote display.

### BACKGROUND

Processors, such as graphics processing units (GPUs) and accelerated processing units (APUs), have been developed to assist in the expedient display of computer generated images and video. Typically, a two-dimensional (2D) and/or three-dimensional (3D) engine associated with a processor may render images and video as data (i.e., pixel data) that are stored in frame buffers of system memory, typically in an RGB (red/green/blue) format. A display controller in the processor may be used to retrieve the image/video frame data and process the data in a selected manner to provide a desired type of video signal output. Where applicable, the display controller may also retrieve and process related audio and cursor control data in connection with the image/video frame data.

A display controller may produce a data stream wherein the video data is included as YUV samples. YUV is a standard color encoding system, such as YCbCr used for digital video compression. The YUV color space (color model) differs from RGB formats that typical cameras capture. The “Y” in YUV stands for “luma,” which is brightness, or lightness; the “U” and “V” stand for “chrominance” or color. Black and white televisions (TVs) decode only the Y part of a YUV signal.

Chrominance, (i.e., chroma), is the signal used in video systems to convey the color information of the picture, separately from the accompanying luma (Y) signal. Chroma is usually represented as two color-difference components: U=B′−Y′ (blue−luma) and V=R′−Y′ (red−luma). Each of these difference components may have scale factors and offsets applied to it, as specified by the applicable video standard. The “U” and “V” provide color information and are “color difference” signals of blue minus luma (B−Y) and red minus luma (R−Y). Through a process called “color space conversion,” a video camera may be configured to convert RGB data captured by its sensors into either composite analog signals (YUV) or component versions (analog YPbPr or digital YCbCr). For rendering on screen, these color spaces are typically converted back to RGB by the TV or other display.

Typically, a processor will have multiple types of standard display outputs. Current standard types of outputs include digital-to-analog converter (DAC) outputs used to drive many commercially available types of cathode ray tube (CRT) monitors/panels/projectors via an analog video graphics array (VGA) cable, digital visual interface (DVI) outputs used to provide very high visual quality on many commercially available digital display devices such as flat panel displays, and high-definition multimedia interface (HDMI) outputs used as a compact audio/video interface for uncompressed digital data for many high-definition televisions or the like. In addition, DisplayPort (DP) outputs may be used. A display controller that has multiple modes will also usually support standard conventional functions of cursor compositing, image rescaling, color space conversion, gamma control and the like for wired display interfaces.

Additionally, processors may have multiple, (e.g., two, four or six), display controllers in order to concurrently drive multiple display outputs to concurrently display the same and/or different images or video on different display devices. Typically, the display controllers are associated with the processor's display outputs in a multiplexed configuration such that any one of the display controllers can be directed to drive any one of the processor's display outputs.

FIG. 1 illustrates an example block diagram of a conventional display control unit 100 having a plurality of display controllers 105₁, 105₂, 105₃ and 105₄, a plurality of multiplexers (MUXs) 110₁, 110₂, 110₃ and 110₄, and a plurality of display output components 115₁, 115₂, 115₃ and 115₄. Each display controller 105 receives display, audio and cursor data 120 from system memory (not shown), and outputs display data signals 125₁, 125₂, 125₃ and 125₄, all of which are received by each of the MUXs 110₁, 110₂, 110₃ and 110₄. In the example shown in FIG. 1, the MUX 110₁ outputs a display output signal 130₁ for driving a DAC output component 115₁, the MUX 110₂ outputs a display output signal 130₂ for driving a first DVI output component 115₂, the MUX 110₃ outputs a display output signal 130₃ for driving a second DVI output component 115₃, and the MUX 110₄ outputs a display output signal 130₄ for driving an HMDI output component 115₄.

In operation, for example, the display control unit 100 may receive setup instructions for the display controller 105₂ to be used to generate the display output signal 130₄ for driving the HDMI output component 115₄. The display control unit 100 accordingly configures the display controller 105₂ to access the appropriate portion of system memory from which to retrieve a display frame and related data for processing into a data stream from which an HDMI formatted signal with selected video characteristics can be created. The MUX 110₄ is controlled to pass the data stream being generated by the display controller 105₂ to the HDMI output component 115₄ for appropriate formatting and output.

The display control unit 100 may also have received setup instructions for the display controller 105₁ to be used to generate the display output signal 130₂ for driving the first DVI output component 115₂. The display control unit 100 accordingly configures the display controller 105₁ to access the appropriate portion of system memory from which to retrieve a display frame and related data for processing into a data stream from which a DVI formatted signal can be created. The MUX 110₂ is controlled to pass the data stream being generated by the display controller 105₁ to the first DVI output component 115₂ for appropriate formatting and output. The portion of the system memory accessed for processing display data into the data stream for creating the DVI formatted signal may be different than the portion of memory being accessed for processing display data into the data stream for creating the HDMI formatted signal in order to display different images or video on different display devices that respectively receive signals output from the first DVI output component 115₂ and the HDMI output component 115₄.

Similarly, the display control unit 100 may also have received setup instructions for the display controllers 105₃ and 105₄ to output selected types of signals from the output components 115 not being used by the display controllers 105₁ and 105₂.

Generally, through a predetermined setup process, a display controller 105 may be configured to drive a particular output component to produce a desired display size, refresh frequency, color quality, resolution and/or other display characteristics. The setup configuration is typically changed to direct the display controller 105 to assume a configuration to drive the same or a different output component 115 when different display characteristics are desired.

One display controller 105 may concurrently drive a plurality of output components 115 if the same display characteristics are desired. Accordingly, the display control unit 100 may receive setup instructions for the display controller 105₁ to produce a data stream from which a DVI signal of the same image, or video with the same characteristics, is output from both the first and second DVI output components 115₂ and 115₃. Thus, the MUXs 110₂ and 110₃, that are respectively associated with the first DVI output component 115₂ and the second DVI output component 115₃, are both controlled to respectively pass the data stream being generated by the display controller 105₁ to the first DVI output component 115₂ and the second DVI output component 115₃.

Although many devices have built-in displays or direct cable connections for display devices, there are expanding applications for sending display outputs from video or graphics sources to remote locations over wired or wireless networks. In lieu of transmitting standard uncompressed display data, network bandwidth constraints have led to data compression transmission requirements that are required to be applied to a display data stream for remote display. Typical wired and wireless networks include Ethernet, universal serial bus (USB) or similar connectivity for Wi-Fi, WiGig, WirelessHD, wireless home digital interface (WHDI), and the like.

A variety of devices have been developed to convert the various types of standard graphic outputs for sending display outputs from video or graphics sources to remote locations over wired or wireless networks.

DisplayLink makes USB-based display attachments. These devices either copy (i.e., screen scrape) from a computer's processor for clone mode, or setup an additional “virtual processor” to establish an extended desktop surface. Use of the computer's processor and system memory is generally required to define a suitable video and/or audio stream for transmission of the display data via the USB interface. The processor may also be needed for audio capture, and audio/video (AV) stream multiplexing.

Intel WiDi technology is an example of a system similar to DisplayLink, but where the network is WiFi rather than USB, and the compression method is MPEG2 rather than the custom compression method used by DisplayLink. Intel WiDi has the same disadvantage in that the processor has to perform many steps, which impacts system power, image quality and usability, (e.g., cursor movement delay).

Several vendors produce “wireless HDMI” type products. These products consist of a transmission (TX) unit that plugs into an HDMI output of a computer or other device, such as a Blu-ray player, and the like, and a reception (RX) unit that plugs into the HDMI input of a display. TX units that implement compression for WiFi network transmission using image compression methods defined with respect to H.264 and MPEG2 standards are desirable, because it is becoming likely that RX capability will be built into future displays, such as network connected TVs. However, this implies more cost on the TX side, because H.264 and MPEG2 require a large memory for performing compression that must be added to discrete TX units.

A method and apparatus is desired for capturing video and audio display data from a display control unit and sending the data to remote locations without having to rely on a large memory device.

### SUMMARY OF EMBODIMENTS OF THE INVENTION

A method and apparatus are described for generating a display data stream for transmission to a remote display. A display control unit in a processor is configured to multiplex the outputs of a plurality of display controllers to generate a video data stream. A video compression engine (VCE) in the processor receives the video data stream directly from the display control unit without having to go through an external memory or an external display interface. The VCE forwards processed video data for transmission to the remote display. In one embodiment, audio and video data may be synchronized into a multiplexed audio/video stream, and optionally encrypted. In another embodiment, separate audio and video streams (optionally encrypted) may be forwarded for transmission to the remote display. A video encoder in the VCE may be configured to compress the video stream. The processed video data may be compressed by the VCE in accordance with different compression schemes. The VCE may simultaneously provide compressed processed video data via multiple outputs. The multiple outputs may include streams compressed in accordance with different compression schemes.

In one embodiment, a computer-readable storage medium stores a set of instructions for execution by one or more processors to facilitate manufacture of a semiconductor device. The semiconductor device includes a display control unit configured to generate a video data stream, and a VCE electrically connected to the display controller. The VCE comprises a video capture unit configured to receive the video data stream directly from the display control unit and generate processed video data based on the video data stream. The VCE is configured to forward the processed video data for transmission to a remote display. The instructions may be Verilog data instructions or hardware description language (HDL) instructions.

### BRIEF DESCRIPTION OF THE DRAWINGS

A more detailed understanding may be had from the following description, given by way of example in conjunction with the accompanying drawings wherein:

FIG. 1 is a block diagram of an example of a conventional design of a processor;

FIG. 2 is a block diagram of an example of a processor that includes an example display control unit and an example video compression engine (VCE) configured in accordance with an embodiment of the present invention;

FIGS. 3A and 3B, taken together, are a flow diagram of a procedure of generating an audio/video stream for a remote display in accordance with an embodiment of the present invention;

FIG. 4 is a block diagram of an example processor in accordance with an embodiment of the present invention whereby separate video and audio streams are generated; and

FIG. 5 is a block diagram of an example processor in accordance with an embodiment of the present invention whereby a single multiplexed video/audio stream is generated.

### DETAILED DESCRIPTION OF PREFERRED EMBODIMENTS

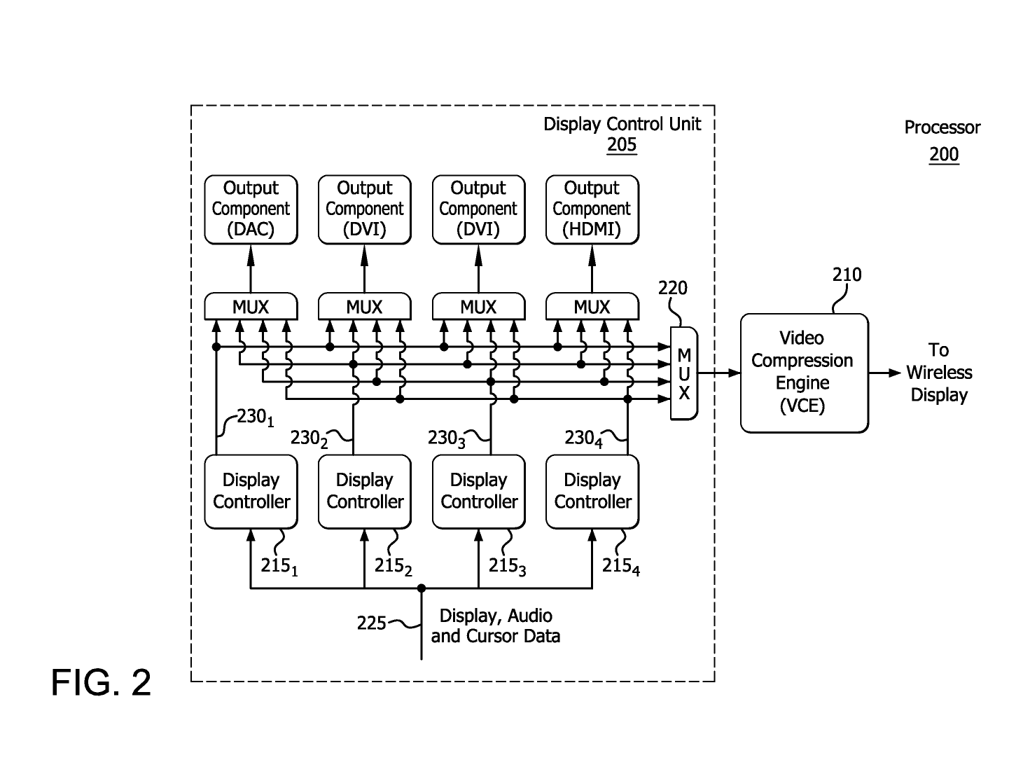

Referring to FIG. 2, an example of a processor 200 is illustrated that has a example display control unit 205 and an example on-chip video compression engine (VCE) 210. The VCE 210 is directly connected to the display control unit 205 without having to go through an external memory or an external display interface.

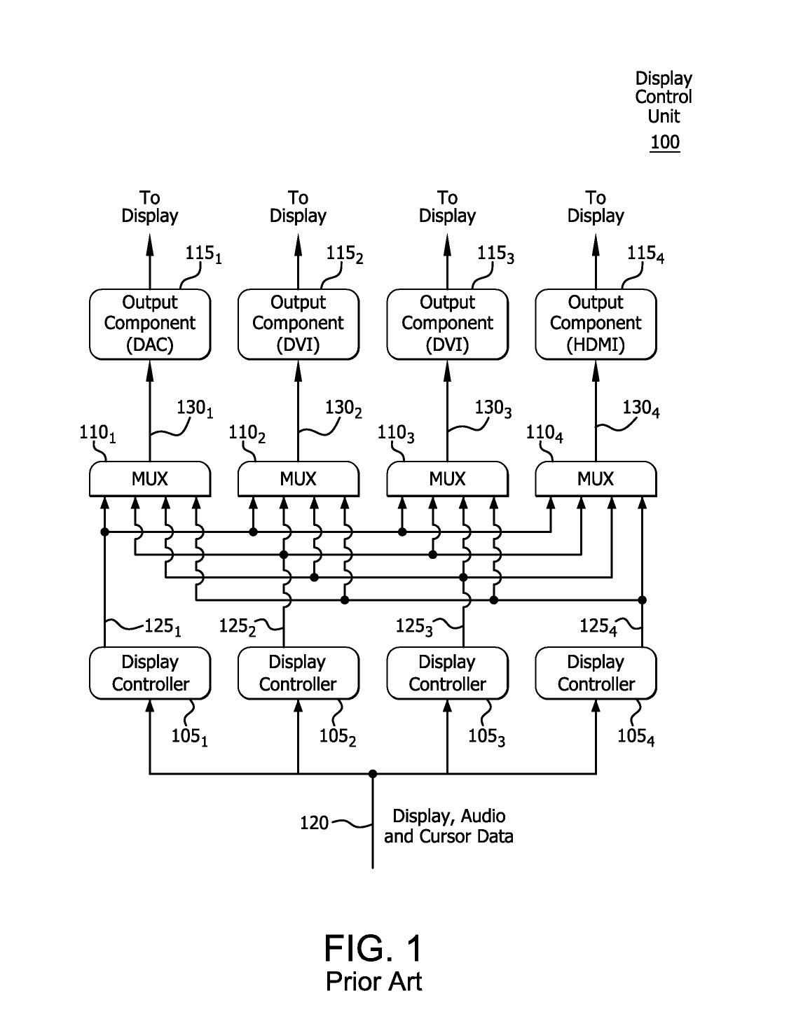

The example display control unit 205 includes a plurality of display controllers 215₁, 215₂, 215₃ and 215₄, a plurality of MUXs that feed a plurality of output components, similar to the conventional display control unit 100 of FIG. 1. Each display controller 215 receives display, audio and cursor data 225 from system memory (not shown), and outputs display data signals 230₁, 230₂, 230₃ and 230₄, all of which are received by each of the MUXs, in a similar fashion as was described for the conventional display control unit 100 of FIG. 1. However, in accordance with an embodiment of the present invention, the display control unit 205 further includes a MUX 220, separate from the MUXs that feed the display output components, which also receives the display data signals 230₁, 230₂, 230₃ and 230₄ and provides a data stream that includes video data to the VCE 210 from a selected display controller 215. When a data stream from one of the display controllers 215 is directed to the VCE 210, the VCE 210 processes it and outputs a VCE output stream that includes a compressed video stream derived from the video data of the data stream.

Although the example display control unit 205 shown in FIG. 2 has a specific number of display controllers 215 and output components, the display control unit 205 may be configured with any desired combination of display controllers 215 and output components. Where only one display controller is provided, the multiplex devices of the type illustrated in FIG. 2 may not be required, but a single multiplexor device may be included to selectively drive multiple display output components dependent upon the data stream that is generated by the single display controller. Still referring to FIG. 2, the VCE 210 of the example processor 200 is configured to receive a data stream of selectively processed rendered display data from a selected one of the display controllers 215 via the multiplexer 220 and to generate a compressed video stream from the video data of the data stream for inclusion in its output from the processor 200. The display controllers 215, for example, may be configurable to receive rendered display data in frames and to process such rendered display data into a data stream that includes YUV/RGB 4:4:4 samples as video data. The VCE 210 is then configured to generate a compressed video stream from the YUV/RGB 4:4:4 samples.

As a further example, the display controllers 215 may be configurable to receive rendered display data 225 that includes related audio and cursor data and to process such rendered display data into a data stream that includes video data samples and related audio data. The VCE 210 is then preferably configured to generate the compressed video stream from the video data samples and to selectively combine the compressed video stream with the related audio data in the VCE output stream. The combination of the audio data may either pass through audio or multiplex audio. Where the compressed video stream is multiplexed with the related audio data, the VCE 210 is preferably configured to generate a display data stream suitable for wireless communication to drive a remote display as the VCE output stream.

Optionally, the VCE 210 can be configured to generate an encrypted VCE output stream. For example, the VCE 210 may be configured to generate the encrypted VCE output stream by using high-bandwidth digital content protection (HDCP) encryption.

The inclusion of the on-chip VCE 210 in the processor 200 facilitates the efficient creation of a display data stream for sending display data to remote locations over wired or wireless networks. Preferably, the VCE 210 is configured to output separate or multiplexed audio and video streams, suitable for transmission over wired and/or wireless networks including Ethernet, USB or similar connectivity for Wi-Fi, WiGig, WirelessHD, WHDI or similar networks.

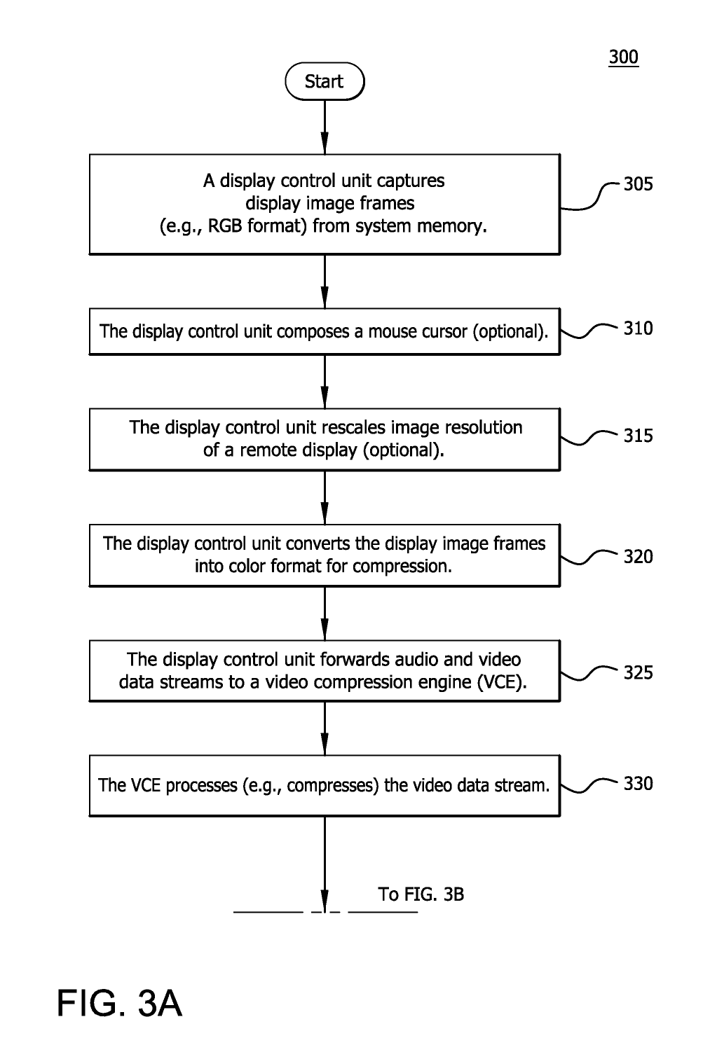

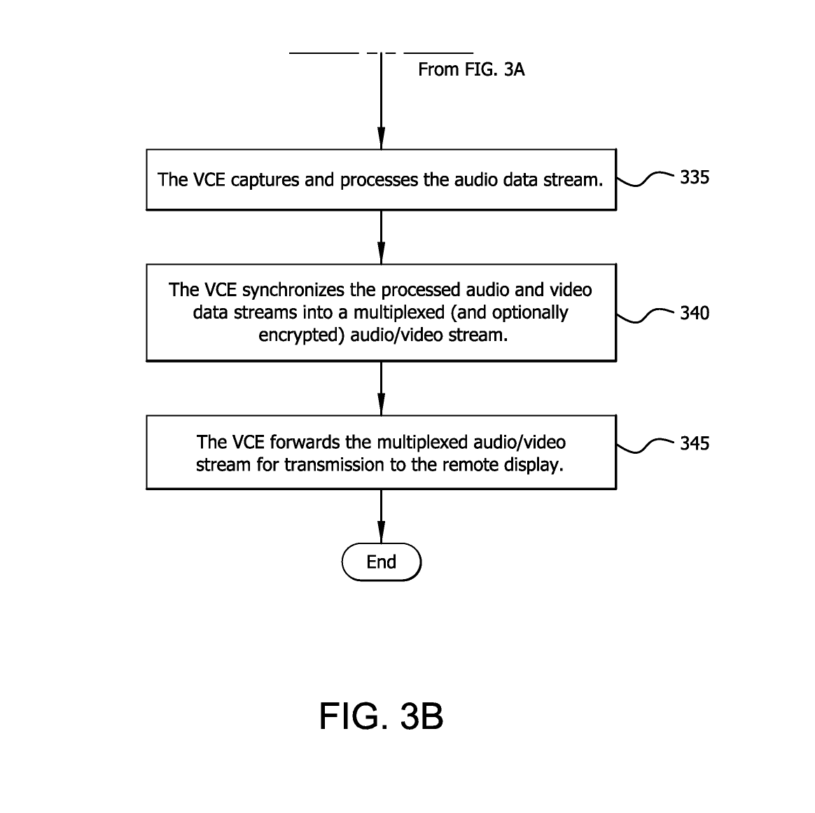

FIGS. 3A and 3B, taken together, are a flow diagram of a procedure 300 of generating an audio/video stream for a remote display in accordance with an embodiment of the present invention. Referring to FIGS. 2 and 3A, in step 305, a display control unit 205 captures display image frames, i.e., display data 225, (e.g., in RGB format), from system memory. In optional step 310, the display control unit 205 composes a mouse cursor, if needed. In optional step 315, the display control unit 205 rescales image resolution of a remote display, if needed. In step 320, the display control unit 205 converts the display image frames into color format for compression. In step 325, the display control unit 205 forwards audio and video data streams to a VCE 210. In step 330, the VCE 210 processes (e.g., compresses) the video data stream. Referring to FIGS. 2 and 3B, in step 335, the VCE 210 captures and processes the audio data stream. In step 340, the VCE 210 synchronizes the processed audio and video data streams into a multiplexed, (and optionally encrypted), audio/video stream. In step 345, the VCE 210 forwards the multiplexed audio/video stream for transmission to the remote display.

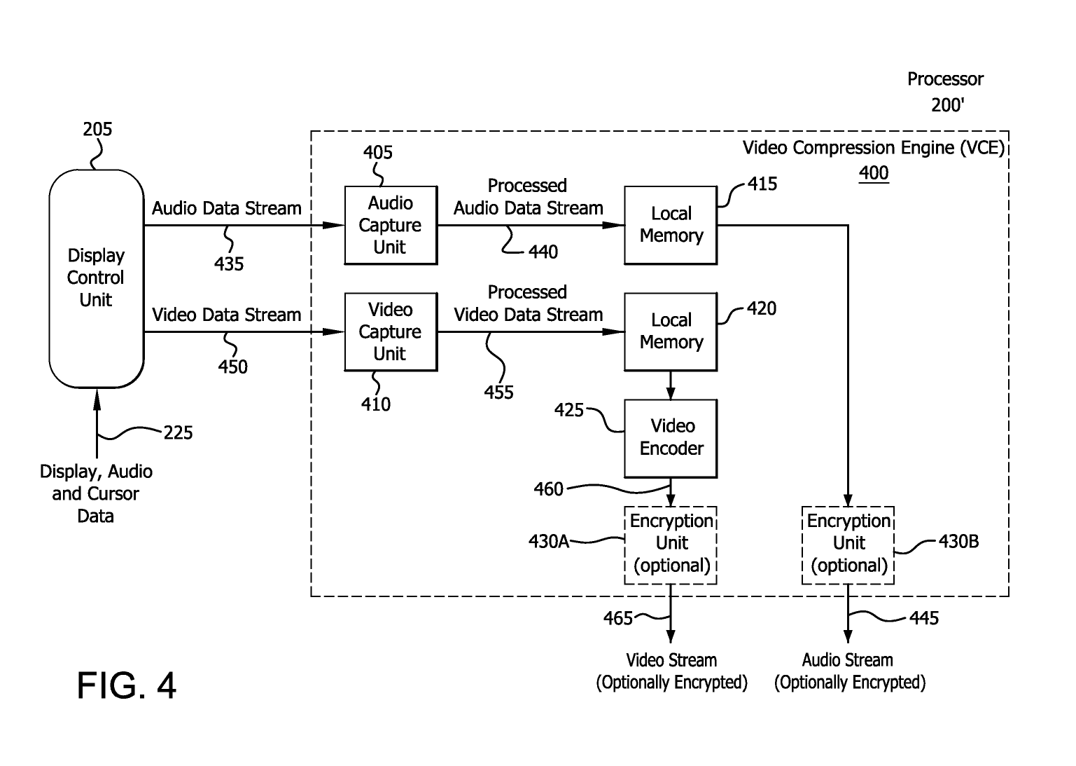

FIG. 4 is a block diagram of an example processor 200′ in accordance with an embodiment of the present invention whereby separate video and audio streams are generated. The processor 200′ includes the display control unit 205 shown in FIG. 2, and a VCE 400. The VCE 400 may include an audio capture unit 405, a video capture unit 410, a local memory 415, a local memory 420, a video encoder 425 and, optionally, encryption units 430A and 430B. The audio capture unit 405 is configured to receive an audio data stream 435 from the display control unit 205, and output a processed audio data stream 440. Alternatively, the audio data stream 435 may be received from a separate audio controller, a memory device and the like. The local memory 415 is configured to store the processed audio data stream 440 that is used to generate an audio stream 445, which optionally may be encrypted by the encryption unit 430B. The video capture unit 410 is configured to receive a video data stream 450 from the display control unit 205, and output a processed video data stream 455. The local memory 420 is configured to store the processed video data stream 455 that is output to the video encoder 425 for generating a compressed video stream 460, which optionally may be encrypted by the encryption unit 430A to generate an encrypted compressed video stream 465. As will be appreciated, the VCE 400 could be embodied so as to output video and/or audio streams that are compressed in accordance with different compression schemes (e.g., MPEG-2, H.264, etc.). Additionally or alternatively, the VCE 400 could be embodied to provide such differently compressed streams either simultaneously (via multiple outputs) or sequentially.

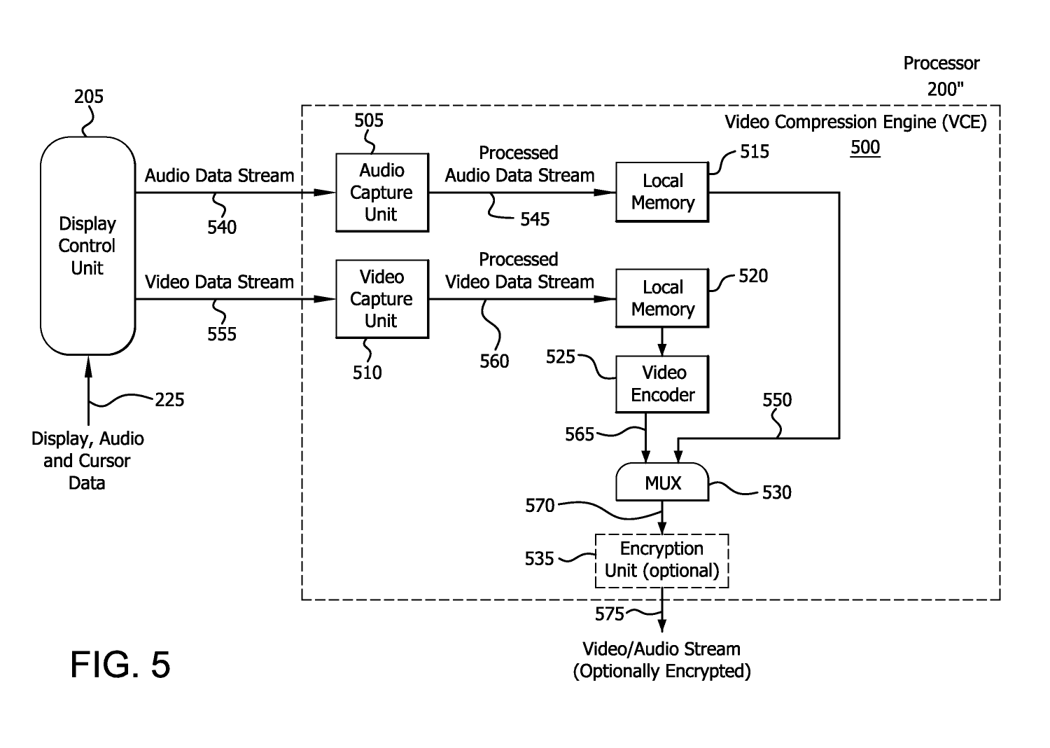

FIG. 5 is a block diagram of an example processor 200″ in accordance with an embodiment of the present invention whereby a multiplexed video/audio stream is generated. The processor 200″ includes the display control unit 205 shown in FIG. 2, and a VCE 500. The VCE 500 may include an audio capture unit 505, a video capture unit 510, a local memory 515, a local memory 520, a video encoder 525, a MUX 530 and, optionally, an encryption unit 535. The audio capture unit 505 is configured to receive an audio data stream 540 from the display control unit 205, and output a processed audio data stream 545. Alternatively, the audio data stream 540 may be received from a separate audio controller, a memory device and the like. The local memory 515 is configured to store the processed audio data stream 545. The video capture unit 510 is configured to receive a video data stream 555 from the display control unit 205, and output a processed video data stream 560. The local memory 520 is configured to store the processed video data stream 560, which is output to the video encoder 525 for generating a compressed video stream 565. The local memory 515 outputs an audio data stream 550 that is multiplexed with the compressed video stream 565 by the MUX 530 to generate a compressed video/audio stream 570, which optionally may be encrypted by the encryption unit 535 to generate an encrypted compressed video/audio stream 575.

Referring to FIGS. 2 and 5, the display control unit 205 may be provided with setup instructions to configure a selected display controller 215 to assume a configuration to receive, for example, RGB formatted image frame data, along with any associated cursor and audio data 225. The selected display controller 215 receives and processes display frame data 225 into a selected data stream for input to the VCE 500, for example, into the video data stream 555 that includes YUV/RGB 4:4:4 samples, which may include cursor data if received. The selected display controller 215 may also provide appropriate scaling in connection with generating the video data stream 555 in accordance with setup parameters. Where related audio data is included in the received display frame data 225, the selected display controller 215 may be configured to also provide an audio data stream 540 to the VCE 500 in parallel as part of the data stream.

In this example, the VCE 500 may be configured to generate a compressed video stream from the YUV/RGB 4:4:4 samples. The VCE 500 may also be configured to synchronize the audio data stream 540 into an output stream, preferably in the form of a display stream such as video/audio stream 570 shown in FIG. 5. Optionally, the VCE 500 may be configured to generate an encrypted video/audio stream 575 by, for example, using high-bandwidth digital content protection (HDCP) encryption.

In connection with generating an appropriately synchronized audio/video stream, the VCE 500 may be configured to write out an internal image of the encoding via a reference output (not shown) and use that reference data later as the reference for subsequent frames via a reference input (also not shown). Preferably, this referencing function by the VCE 500 is performed with respect to memory that is not on the processor 200″ in order to limit the amount of space required to implement the VCE 500 within the processor 200″.

The use of an on-chip VCE in the processors 200, 200′ and 200″ shown in FIGS. 2, 4 and 5, with a direct connection to the display control unit 205 without having to go through an external memory or an external display interface, saves considerable memory bandwidth and power, eliminates cursor composition delay, as well as reduces encode time and image latency. Various functions related to the generation of the audio/video stream that is output from the processors 200, 200′ and 200″ may be distributed between the display controller 205 and the VCE. For example, the processing by the display controller 205 may be limited so that operations such as color space conversion or rescaling may be performed by the VCE. Various configurations of the display controller 205 and the VCE have advantages and disadvantages in terms of area power and increased flexibility within the processors 200, 200′ and 200″.

Although features and elements are described above in particular combinations, each feature or element can be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), an accelerated processing unit (APU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method of generating a display data stream for a remote display, the method comprising:
a display control unit in a processor generating a video data stream;
a video compression engine (VCE) in the processor receiving the video data stream directly from the display control unit;
the VCE generating processed video data based on the video data stream; and
the VCE forwarding the processed video data for transmission to the remote display.

2. The method of claim 1 further comprising:
the VCE receiving an audio data stream;
the VCE generating processed audio data based on the audio data stream;
the VCE forwarding the processed audio data for transmission to the remote display; and
the VCE storing the processed audio and video data in local memory.

3. The method of claim 1 further comprising:
the VCE compressing the processed video data in accordance with different compression schemes.

4. The method of claim 1 further comprising:
the VCE simultaneously providing compressed processed video data via multiple outputs.

5. The method of claim 4 wherein the multiple outputs include streams compressed in accordance with different compression schemes.

6. The method of claim 2 further comprising:
the VCE synchronizing the processed audio and video data into a multiplexed audio/video stream.

7. The method of claim 6 further comprising:
the VCE encrypting the multiplexed audio/video stream.

8. The method of claim 1 further comprising:
the display control unit capturing display image frames; and
the display control unit converting the display image frames into color format for compression.

9. The method of claim 8 further comprising:
the display control unit rescaling image resolution of the remote display.

10. The method of claim 8 further comprising:
the display control unit composing a mouse cursor.

11. The method of claim 1 further comprising:
the display control unit multiplexing the outputs of a plurality of display controllers in the display control unit to generate the video data stream.

12. A processor comprising:
a display control unit configured to generate a video data stream; and
a video compression engine (VCE) electrically connected to the display controller, the VCE comprising a video capture unit configured to receive the video data stream directly from the display control unit and generate processed video data based on the video data stream, wherein the VCE is configured to forward the processed video data for transmission to a remote display.

13. The processor of claim 12 wherein the VCE further comprises:
an audio capture unit configured to receive an audio data stream and generate processed audio data based on the audio data stream, wherein the VCE is configured to forward the processed audio data for transmission to a remote display; and
a local memory configured to store the processed audio data.

14. The processor of claim 12 wherein the VCE further comprises:
a local memory configured to store the processed video data.

15. The processor of claim 12 wherein the VCE further comprises:
a video encoder configured to compress the processed video data in accordance with different compression schemes.

16. The processor of claim 12 wherein the VCE simultaneously provides compressed processed video data via multiple outputs.

17. The processor of claim 16 wherein the multiple outputs include streams compressed in accordance with different compression schemes.

18. The processor of claim 13 wherein the VCE further comprises:
a multiplexer configured to synchronize the processed audio and video data into a multiplexed audio/video stream.

19. The processor of claim 18 wherein the VCE further comprises:
an encryption unit configured to encrypt the multiplexed audio/video stream.

20. The processor of claim 12 wherein the display control unit comprises:
a plurality of display controllers, each display controller configured to capture display image frames; and
a multiplexer configured to generate the video data stream based on display data received from at least one of the display controllers, wherein the display control unit is configured to convert the display image frames into color format for compression.

21. The processor of claim 12 wherein the display control unit is configured to compose a mouse cursor.

22. A computer-readable storage medium storing a set of instructions for execution by one or more processors to facilitate manufacture of a semiconductor device that includes:
a display control unit configured to generate a video data stream; and
a video compression engine (VCE) electrically connected to the display controller, the VCE comprising a video capture unit configured to receive the video data stream directly from the display control unit and generate processed video data based on the video data stream, wherein the VCE is configured to forward the processed video data for transmission to a remote display.

23. The computer-readable storage medium of claim 22 wherein the instructions are Verilog data instructions.

24. The computer-readable storage medium of claim 22 wherein the instructions are hardware description language (HDL) instructions.
